(19) United States
(12) Patent Application Publication
(10) Pub. No.: US 2026/0122451 A1
(43) Pub. Date: Apr. 30, 2026

(54) USER DEVICE THAT PREVENTS SHARING OR POSTING OF OBJECTIONABLE CONTENT

(71) Applicant: MOTOROLA MOBILITY LLC, Wilmington, DE (US)

(72) Inventors: Amit Kumar AGRAWAL, Bangalore (IN); Panduranga Reddy PAILLA, Nalgonda (IN); Vijayprakash IDLUR, Idlur (IN)

(21) Appl. No.: 18/930,112

(22) Filed: Oct. 29, 2024

(51) Int. Cl. H04W 4/029; G06F 40/279; G06T 7/00

(52) U.S. Cl. CPC H04W 4/029; G06T 7/0002; G06F 40/279; G06T 2207/10016; G06T 2207/20081

(57) ABSTRACT

An electronic device, a method, and a computer program product prevent transmission by a user of the electronic device of objectionable content to another electronic device via a network, to avoid potential negative repercussions. User interface component(s) of the electronic device are configured to receive user inputs via input device(s) and to present content via output device(s). In response to receiving a user input to initiate sharing of content with second electronic device(s) via a communication network, a processor of the electronic device is configured to cause the electronic device to identify whether the content includes objectionable content. In response to determining that the content comprises objectionable content, the processor configures the electronic device to prevent transmission of the objectionable content via the communications subsystem to the second electronic device(s).

### BACKGROUND

### 1. Technical Field

The present disclosure relates generally to electronic devices that can receive and transmit a user input, and more particularly to electronic devices that can analyze content of the user input.

### 2. Description of the Related Art

Electronic devices such as smartphones, laptops, and tablets are often used to receive and share content with other electronic devices. In an example, users may input a written comment in the form of a text, an email, or a social media post that is transmitted directly or indirectly to one or more second electronic devices. In another example, users may capture an image using an image capturing device such as a camera and send the image to other electronic devices. Electronic devices may have capabilities for generating audible, visual, or haptic content under user control that expands the possibilities of generating content. The user may select to share the generated content via direct transmission to other electronic devices or shared to a network device such as a social media system for presenting to other users.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 presents a simplified functional block diagram of a communication device in which the features of the present disclosure are advantageously implemented for automatically analyzing visual, audible, and alphanumeric/text-based content for objectionable content before allowing content transmission, according to one or more embodiments;

FIG. 2 is a simplified block diagram of the communication device having additional communication interfaces for wireless communications, according to one or more embodiments;

FIG. 3 is a front view of a display of the communication device of FIG. 1 presenting an objectionable content evaluation (OCE) interface window for presenting a repercussion report and related controls for objectionable content, according to one or more embodiments;

FIG. 4 is a front view of a display of the communication device of FIG. 1 presenting a texting interface window with a popup OCE interface window for presenting a repercussion report and related controls for text message content, according to one or more embodiments;

FIG. 5A is a diagram of a front view of the display of the communication device presenting a texting interface window with a popup OCE interface window for presenting a repercussion reports in a restricted location according to one or more embodiments;

FIG. 5B is a diagram of a front view of the display of the communication device presenting a texting interface window with a popup OCE interface window for presenting a repercussion reports in an unrestricted location, according to one or more embodiments;

FIG. 6 is a front view of a display of a managing electronic device presenting an OCE managing interface window for monitoring and controlling OCE functionality of the communication device of FIG. 1, according to one or more embodiments;

FIG. 7 is a flow diagram presenting a method for monitoring a managed device using an artificial intelligence (AI) engine running on the managed device for media or messages that contain objectionable content, according to one or more embodiments; and

FIGS. 8A-8B (collectively “FIG. 8”) are a flow diagram presenting a method for preventing transmission of objectionable content to avoid potentially negative social or legal repercussions to a user of the electronic device, according to one or more embodiments.

### DETAILED DESCRIPTION

According to aspects of the present disclosure, an electronic device, a method and a computer program product prevent transmission of objectionable content by a user of the electronic device to avoid potentially negative social or legal repercussions to the user or to others. In an example, the content may at least be arguably objectionable based on a recipient not understanding an attempt at a humor or satire. Content may be ambiguously open to interpretation as a threat. Content may be objectionable as using colloquialisms, terms, metaphors or analogies that are not suitable to a recipient. Content may be an inappropriate or explicit image or audio. In one or more embodiments, the electronic device includes at least one user interface component configured to receive user inputs via one or more input device and to present content via one or more output device. The electronic device includes a memory that stores an objectionable content evaluation module and at least one communication application. The electronic device includes a communications subsystem connectable to a communication network. A processor of the electronic device is communicatively coupled to the memory and the communications subsystem. In response to receiving a user input to initiate sharing of content with at least one second electronic device via the communication network, the processor is configured to cause the electronic device to identify whether the content comprises objectionable content. In response to determining that the content comprises objectionable content, the processor is configured to cause the electronic device to prevent transmission of the objectionable content to the at least one second electronic device.

Social media platforms offer a variety of ways for people to connect and share information. Social media platforms offer a diverse landscape for connecting, sharing, and expressing ourselves. From funny videos to artistic photography, users may actively participate in this digital world, shaping its future with their unique preferences and interests. However, in some instances, a user of an electronic device may be naïve or immature, requiring assistance in discerning what is appropriate to communicate or post. In addition, a normally responsible user may be impaired by mood, intoxication, sleep deprivation, or provocation. Objectionable content may arise when a user intends to entertain, to break the ice, or to instigate a prank. A prank or joke may include discussion of inappropriate use of drugs, alcohol, or weapons, a public disturbance, offensive or obscene language or images, public safety misinformation, and fake emergencies. In some instances, the user may actually intend to do a harmful or shameful act or to say a harmful statement. In certain instances, the objectionable content becomes particularly actionable in certain locations or venues (e.g., government facilities and public transit hubs) where law enforcement monitoring is enhanced.

By automating analysis and prevention of transmission of content before transmission, the present disclosure mitigates or avoids the repercussions of an ill-advised transmission of objectionable content. The analysis may include optical character recognition and image recognition to identify objectionable content. The analysis may utilize a multimodal artificial intelligence (AI) engine, which may further include a large language model (LLM) that has been trained on vast amounts of text to understand existing content and context. The analysis can encompass a number of visual and audible language forms.

In an example, the analysis and prevention of transmission of objectionable content may be summarized in three primary steps. A first step is monitoring. In a set of connected, linked devices, a managing device may implement monitoring of a managed device using an AI engine running on the managed device. The AI engine performs analysis of any social media contents or post generation as well as text communications, such as by monitoring all communication and operations occurring on the managed device. The contents may be in any media formats, such as text, image, videos, graphics interface format (GIFs), documents, audio file, etc. A second step is detecting. The analysis includes detecting and identifying patterns that contain any sensitive content such as pranks involving drugs, alcohol, or weapons, public disturbances, offensive language or humor, spreading misinformation or fake emergencies, etc. The analysis includes detecting and identifying inappropriate content such as nudity in images, videos, obscene gestures and language, etc. The analysis may utilize generative AI algorithms to find objectionable content. The AI algorithm may be trained using previous incidents of objectionable content or media. Activation of the analysis, or heightened scrutiny, may be based on location of the electronic device being at a sensitive location or place such as a secure or sensitive governmental or public venue. A third step is prevention. The analysis may use a defined threshold for tolerable or permissible content, such as by judging whether the humor or satire would not be misinterpreted on face value. The analysis may utilize generative AI algorithms to analyze repercussions of the content or media and/or to block transmission of the content or media. The analysis may trigger a requirement for an override of the transmission block by the managing device to authorize the transmission of the content or media.

Objectionable content may have potential negative repercussions to the sender, the recipient and/or third parties. In an example, the sender may disclose confidential information that subjects the sender, the recipient and/or third parties to identity theft or embarrassment. The objectionable content may include classified national security information. The objectionable content may include slanderous or libelous statements directed toward the sender, the recipient and/or third parties. In each incident, the sender may potentially receive negative repercussions as to being the source of harm to others. For clarity, the present disclosure focuses on the potential negative repercussions to the sender (i.e., user of the electronic device).

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined primarily by the appended claims and equivalents thereof. Within the descriptions of the different views of the figures, similar elements can be provided with similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

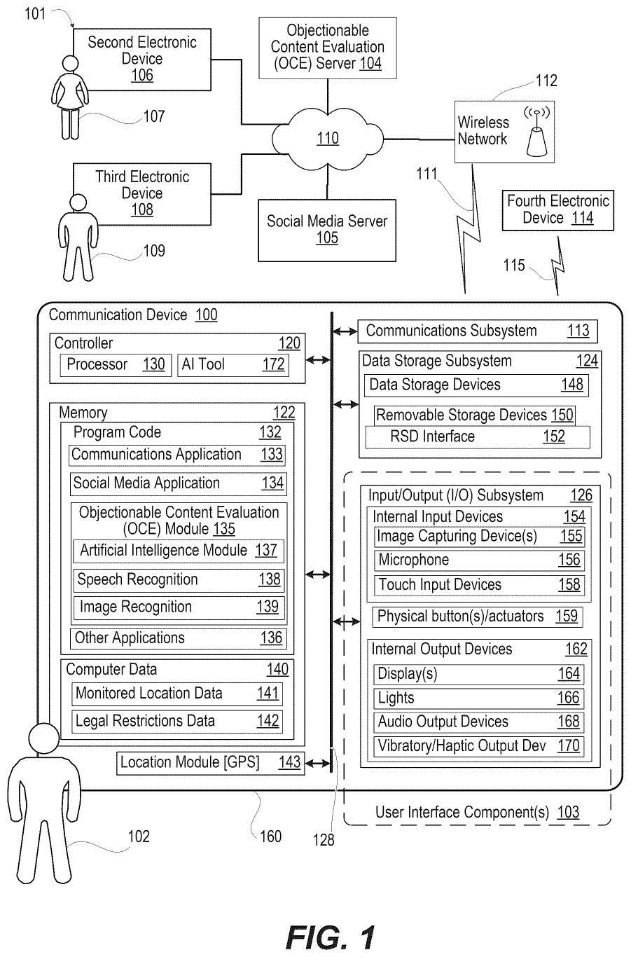

FIG. 1 presents a simplified functional block diagram of an electronic device in which the features of the present disclosure are advantageously implemented to automatically analyze visual, audible, and alphanumeric/text-based content for objectionable content before allowing content transmission, where transmission of certain objectionable content can be blocked. In one or more embodiments, the electronic device includes additional communications functionality that enables electronic device to be referred to as communication device 100, which operates as a mobile user device for user 102 in communication environment 101. Aspects of the present disclosure may be implemented at least in part in objectional content evaluation (OCE) server(s) 104 that includes some or all of the components and functionality described herein. In an example, to reduce power consumption and processing capacity requirements, communication device 100 may distribute processing tasks for evaluating inputs to user interface component(s) 103 of communication device 100 to OCE server(s) 104.

Communication device 100 can be one of a host of different types of devices, including but not limited to, a mobile cellular phone, satellite phone, or smart phone, a laptop, a netbook, an ultra-book, a networked smartwatch, or networked sports/exercise watch, and/or a tablet computing device or similar device that can include wireless communication functionality. As a device supporting wireless communication, communication device 100 can be utilized as, and also be referred to as, a system, device, subscriber unit, subscriber station, mobile station (MS), mobile, mobile device, remote station, remote terminal, user terminal, terminal, user agent, user device, a session initiation protocol (SIP) phone, a wireless local loop (WLL) station, a personal digital assistant (PDA), computer workstation, a handheld device having wireless connection capability, a computing device, or other processing devices.

In the specific example of FIG. 1, communication environment 101 also includes objectionable content evaluation (OCE) server 104, social media server(s) 105 and one or more second electronic device 106 (of corresponding second user 107) and third electronic device 108 (of corresponding second user 109), which are accessible to communication device 100 through communication network 110. Communications device 100 includes communications subsystem 113 that connects via wired or wireless channel 111 to node 112 (e.g., wireless access point, cellular tower) to communicatively connect to OCE server(s) 104, social media server(s) 105, second electronic device(s) 106, and third electronic device 108 via one or more communication network(s) generally presented as network(s) 110. One or more second user 107 may access and consume (i.e., by viewing/reading, listening, or feeling) visual (e.g., text, image, video), audible, or haptic content communicated to second electronic device(s) 106, which may be directly received via network(s) 110 or indirectly received via social media server(s) 105 from communication device 100.

In one or more embodiments, communication device 100 is a managed device within a group of electronic devices that includes third electronic device 108 that is operated by managing user 109. Third electronic device 108 may activate or deactivate OCE module 135 of communication device 100. In one or more embodiments, actions taken by communication device 100 to delay or prevent transmission of objectionable content may be reported real-time or non-real-time to third electronic device 108. Third electronic device 108 may be able to adjudicate or modify decisions to delay and prevent transmission of particular content or adjust analysis for subsequent content. In an example, user 102 is an immature or incompetent person who is under the supervision or guardianship to managing user 109. In one or more embodiments, user 102 may operate more than one connected device, which for clarity is depicted as communication device 100 connected to fourth electronic device 114 via wired or wireless channel 115. In an example, communication device 100 may be a smartphone and fourth electronic device 114 may be a desktop workstation, tablet or laptop. Aspects of the present disclosure may perform objectionable content evaluation for all of the connected devices, which may include mirroring user interfaces and enforcing blocking.

Communication device 100 includes controller 120, memory 122, data storage subsystem 124 and input/output (I/O) subsystem 126. To enable management by controller 120, system interlink 128 communicatively connects controller 120 with communications subsystem 113, memory 122, data storage subsystem 124 and I/O subsystem 126. System interlink 128 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (i.e., system interlink 128) are illustrated in FIG. 1, it is to be understood that more, fewer, or different interconnections may be present in other embodiments.

Controller 120 includes processor 130, which includes one or more central processing units (CPUs) or data processors. Processor 130 can include one or more digital signal processors and graphics processing units (GPUs), etc. that can be integrated with data processor(s). Processor 130 can include other processors such as auxiliary processor(s) that may act as a low power consumption, always-on sensor hub for physical sensors. Controller 120 manages, and in some instances directly controls, the various functions and/or operations of communication device 100. These functions and/or operations include, but are not limited to including, application data processing, communication, navigation tasks, image processing, and signal processing. In one or more alternate embodiments, communication device 100 may use hardware component equivalents for application data processing and signal processing. For example, communication device 100 may use special purpose hardware, dedicated processors, general purpose computers, microprocessor-based computers, micro-controllers, optical computers, analog computers, dedicated processors and/or dedicated hard-wired logic.

Memory 122 stores program code 132 for execution by processor 130 to provide the functionality described herein. Memory 122 further includes operating system (OS), firmware interface, such as basic input/output system (BIOS) or Uniform Extensible Firmware Interface (UEFI), and firmware, which also includes and may thus be considered as program code 132. Program code 132 includes applications such as communication application 133 for communicating with second electronic device(s) 106, social media application 134 for interacting with social media server(s) 105, and OCE module 135. Program code 132 can also include other applications 136. OCE module 135 may include artificial intelligence (AI) model 137, audible or visual speech recognition module 138, and image recognition module 139. In an example, a captured video of user 102 may include objectionable text, objectionable spoken words, and/or objectionable graphical content (e.g., obscene body parts or bodily activities).

In one or more embodiments, several of the described aspects of the present disclosure are provided via executable program code of applications executed by controller 120. In one or more embodiments, program code 132 may be integrated into a distinct chipset or hardware module as firmware that operates separately from executable program code. Portions of program code 132 may be incorporated into different hardware components that operate in a distributed or collaborative manner.

Program code 132 may access, use, generate, modify, store, or communicate computer data 140, such as monitored location data 141 and legal restrictions data 142 for OCE module 135 to use in evaluating objectional content. Monitored location data 141 may be provided by location module 143, such as a GPS module. Computer data 140 may incorporate “data” that originated as raw, real-world “analog” information that consists of basic facts and figures. Computer data 140 includes different forms of data, such as numerical data, images, coding, notes, and financial data. Computer data 140 may originate at communication device 100 or be retrieved from a remote device via communications subsystem 113. Communication device 100 may store, modify, present, or transmit computer data 140, such as legal restrictions data 142. Computer data 140 may be organized in one of a number of different data structures. Common examples of computer data 140 include video, graphics, text, and images. Computer data 140 can also be in other forms of flat files, databases, and other data structures.

Data storage subsystem 124 of communication device 100 includes data storage device(s) 148. Controller 120 is communicatively connected, via system interlink 128, to data storage device(s) 148. Data storage subsystem 124 provides program code 132 and computer data 140 stored on nonvolatile storage that is accessible by controller 120. For example, data storage subsystem 124 can provide a selection of program code 132 and computer data 140. These applications can be loaded into memory 122 for execution/processing by controller 120. In one or more embodiments, data storage device(s) 148 can include hard disk drives (HDDs), optical disk drives, and/or solid-state drives (SSDs), etc. Data storage subsystem 124 of communication device 100 can include removable storage device(s) (RSD(s)) 150, which is received in RSD interface 152. Controller 120 is communicatively connected to RSD 150, via system interlink 128 and RSD interface 152. In one or more embodiments, RSD 150 is a non-transitory computer program product or computer readable storage device that stores program code and/or instructions that may be executed by a processor associated with a user device such as communication device 100. Controller 120 can access data storage device(s) 148 or RSD 150 to provision communication device 100 with program code 132 and computer data 140.

I/O subsystem 126 may include internal input devices 154 such as image capturing device(s) 155, microphone 156, and touch input devices 158 (e.g., screens, keys, or buttons). I/O subsystem 126 may include physical buttons/actuators 159 that can be located on a periphery of the device housing 160. I/O subsystem 126 may include internal output devices 162 such as display(s) 164, lights 166, audio output devices 168, and vibratory or haptic output devices 170.

In one or more embodiments, OCE module 135 includes AI model 137 that is trained to recognize objectionable content. OCE module 135 and AI model 137 may be stored in memory 122 of communication device 100 and be executed by controller 120 to perform various aspects of the functionality of the present disclosure. Training of AI model 137 is the process by which AI models are trained to perform specific tasks or achieve certain objectives. The training involves providing the model with a large amount of data and allowing the model to learn from patterns and relationships within that data. Controller 120 may include various functionalities, such as an integrated AI tool 172, that enable controller 120 to perform different aspects of AI models. AI models may include an artificial neural network, a decision tree, a support vector machine, Hidden Markov model, linear regression, logistic regression, Bayesian networks, and so forth. The AI models can be individually trained to perform specific tasks and can be arranged in different sets of AI models to generate different types of output.

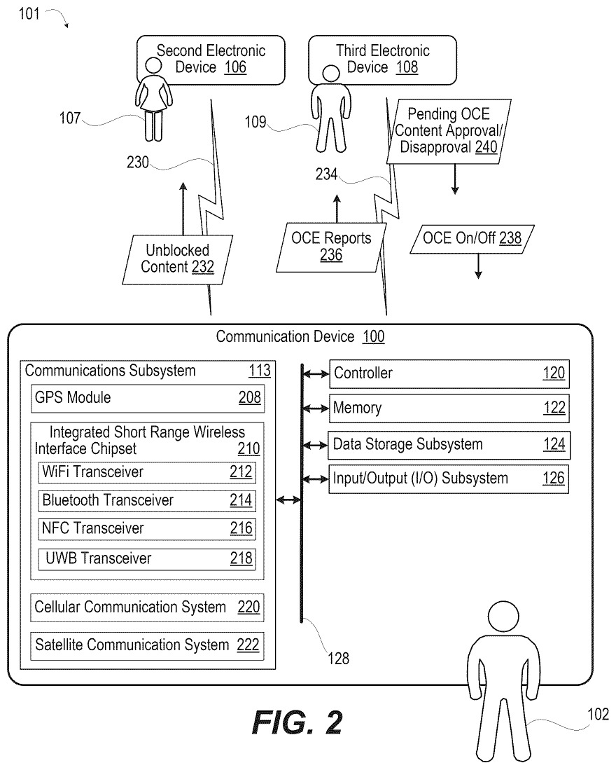

FIG. 2 is a simplified block diagram of communication device 100 having additional communication interfaces for wireless communications. In one or more embodiments, controller 120, via communications subsystem 113, performs multiple types of cellular over-the-air (OTA) or wireless communication, such as by using a Bluetooth connection or other personal access network (PAN) connection. In an example, a user may wear a health monitoring device such as a smartwatch that is communicatively coupled via a wireless connection. In one or more embodiments, communications subsystem 113 includes a global positioning system (GPS) module 208 that receives GPS broadcasts from GPS satellites to obtain geospatial location information. In one or more embodiments, controller 120, via communications subsystem 113, communicates via a wireless local area network (WLAN) link using one or more IEEE 802.11 WLAN protocols with an access point. In one or more embodiments, controller 120, via communications subsystem 113, may communicate via an OTA cellular connection with radio access networks (RANs). In an example, communication device 100, via communications subsystem 113, connects via RANs of a terrestrial network that is communicatively connected to a network server. In one or more embodiments, communications subsystem 113 includes integrated short range wireless interface chipset 210 having one or more of Wi-Fi component 212, Bluetooth (BT) transceiver (TxRx) 214, near field communication (NFC) transceiver 216, and ultra-wideband (UWB) transceiver 218. In one or more embodiments, communications subsystem 113 further includes long distance communication capabilities including cellular communication system 220 and satellite communication system 222.

Communication device 100 may communicate with second electronic device 106 directly or indirectly via communication link 230 using one or more wired or wireless capabilities of communications subsystem 113. In an example, unblocked content 232 may be transmitted via communication link 230 to second electronic device 106 for presenting to second user 107. Communication device 100 may communicate with managing electronic device 108 directly or indirectly via communication link 234 using one or more wired or wireless capabilities of communications subsystem 113. In an example, OCE reports 236 may be transmitted via communication link 230 to managing electronic device 108 for presenting to managing user 109. Managing electronic device 108 may communicate OCE on/off commands 238 and pending OCE content approval/disapproval commands 240.

With particular reference to FIG. 1, according to aspects of the present disclosure, an electronic device such as communication device 100 includes at least one user interface component 103 configured to receive user inputs via one or more internal input device 154 and to present content via one or more internal output device 162. Communication device 100 includes memory 122 that stores at least one communication application 133 and objectionable content evaluation (OCE) module 135. Communication device 100 includes communications subsystem 113 that is connectable to communication network 110. Processor 130 is communicatively coupled to memory 122 and communications subsystem 113. In response to receiving a user input to initiate sharing of content with at least one second electronic device 106 via communication network 110, processor 130 is configured to cause communication device 100 to identify whether the content includes objectionable content. In response to determining that the content includes objectionable content, processor 130 is configured to cause communication device 100 to prevent transmission of the objectionable content via communications subsystem 113 to at least one second electronic device 106. In one or more embodiments, processor 130 is configured to cause communication device 100 to prevent transmission of the content via communications subsystem 113 to at least one second electronic device 106, at least in part in response to determining that at least one second electronic device 106 is associated with a social media system (e.g., social media server(s) 105).

In one or more embodiments, processor 130 is configured to cause communication device 100 to determine a location of communication device 100. The location data can be received from location module 143. Processor 130 is configured to cause communication device 100 to perform at least one of: (i) identifying the objectionable content at least in part based on the location of communication device 100; and (ii) blocking the transmission of the objectionable content based at least in part on the location of communication device 100 being at a location monitored by a third party (e.g., a law enforcement authority).

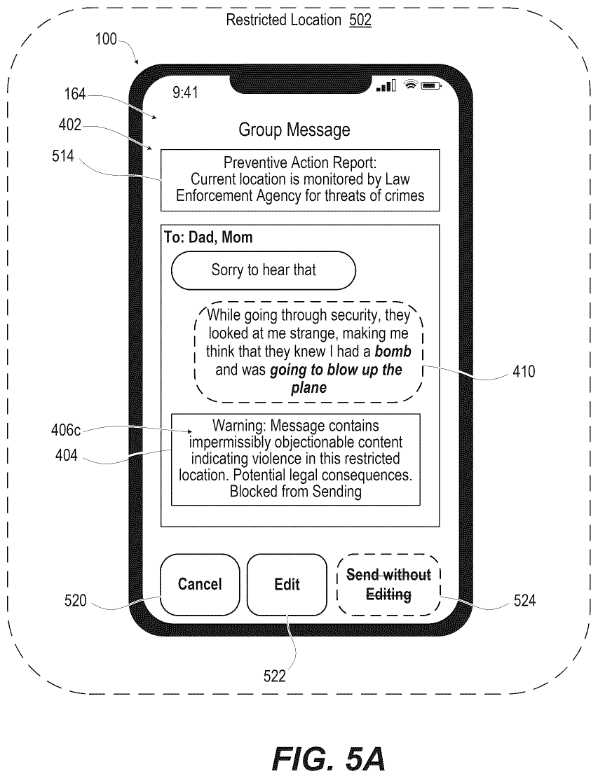

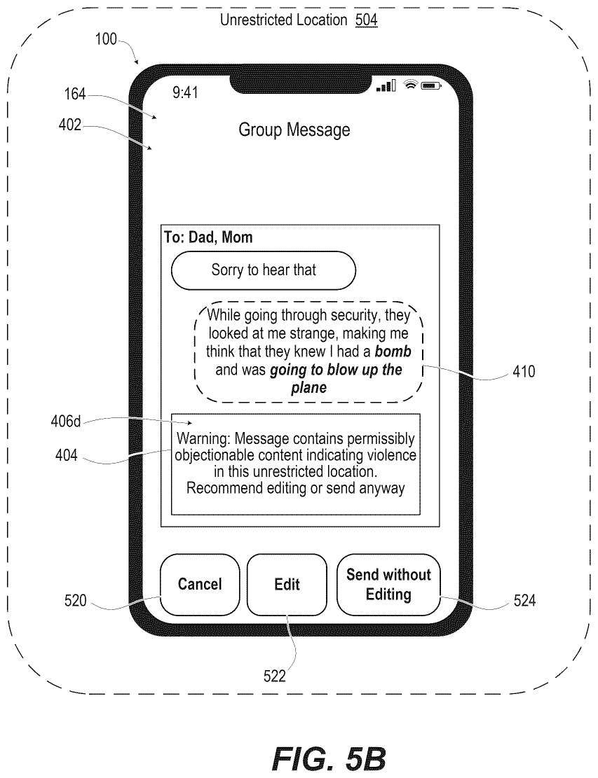

In one or more embodiments, processor 130 is configured to cause communication device 100 to determine a location of communication device 100. The location can be received from location module 143. Alternatively, in one or more embodiments, the location can be determined based on location data corresponding to the closest cellular tower to which the device is connected. Processor 130 is configured to cause communication device 100 to determine whether the content includes objectionable content based on at least one legal or other form of restriction that governs or is to be applied within the location. Processor 130 is configured to cause communication device 100 to perform at least one of: (i) identifying the objectionable content, at least in part based on the location of communication device 100; and (ii) blocking the transmission of the objectionable content based on determining that the content is objectionable content based on at least one restriction that governs or is applicable to the location. An example is depicted below regarding FIG. 5.

In one or more embodiments, the content includes visual content from at least one of: (i) text; (ii) an image; (iii) a video; (iv) graphics interchange format (GIF); (v) emoji; (vi) quiz/poll; (vi) online link; and (vii) a meme. Objectionable content evaluation (OCE) module 135 includes an artificial intelligence (AI) module 137 trained to detect objectionable content from within visual content. In one or more particular embodiments, communication device 100 further includes image capturing device(s) 155 that are communicatively coupled to processor 130. Processor 130 is further configured to cause communication device 100 to evaluate the visual content for objectionable content in response to at least one of detecting: (i) generation of one of an image and the video by image capturing device(s) 155; and (ii) receipt of user input (e.g., via one or more internal input device 154) selecting the one of the image and the video for transmission. In one or more embodiments, the content includes audible communication. OCE module 135 includes AI module 137 trained to detect objectionable content within audible communication.

In one or more embodiments, processor 130 is configured to cause communication device 100 to evaluate the objectionable content as corresponding to one of at least two categories comprising impermissible objectionable content and permissible objectionable content. Processor 130 is configured to cause communication device 100 to generate and present a notification of a type of objectionable content found within the content. Processor 130 is configured to cause communication device 100 to prevent transmission of impermissible objectionable content. Processor 130 is configured to cause communication device 100 to allow user selection to enable transmission of objectionable content evaluated as permissible objectionable.

As utilized herein, impermissible content may be defined according to local custom, legal dictates, ethical definitions, religious mores, etc., as statements that are not allowed/permitted/approved in polite society because the statement can potentially cause panic, distress, or prompt reactionary response. As an example, threats of violence to children, the disabled, the elderly, or other innocent persons may be deemed impermissible and not the subject of any allowable jest. In another example, images or videos, whether real or simulated, of sex with minors is impermissibly objectionable. Objectionable content that is permissible may be socially frowned upon as creating disparagement toward the person generating the content or receiving the content but is not in an impermissible category. In an example, saying that you intend to “bruise” the players on the opposing team in an upcoming game may be deemed permissible, while saying that you are going to “kill” player(s) on the opposing team, while hyperbole, falls within the impermissible category. In another example, saying that you hope that a plague of locusts descend upon your enemy may be permissible as obvious hyperbole, evoking an act of nature and not an actual intent of personal violence.

In one or more embodiments, processor 130 is configured to cause communication device 100 to determine that the content includes objectionable content by identifying that the content falls within at least one content category from among objectionable content categories comprising: (i) illegal drugs; (ii) incitement for violent conduct; (iii) alcohol consumption; (iv) weapons; (v) fake emergency; (vi) sexual conduct; (vii) obscene body depiction; (viii) racial slurs; (ix) criminal behavior; and (x) public health misinformation. The categories may include gradations of permissibility and impermissibility. In an example, sexual conduct may be permissible for consensual adult conduct, but be impermissible with regard to incest, bestiality, and pedophilia. Certain categories may be deemed entirely permissible or impermissible for a managed user. For example, an underaged managed user may be blocked from any reference to sexual conduct even with those of the same age.

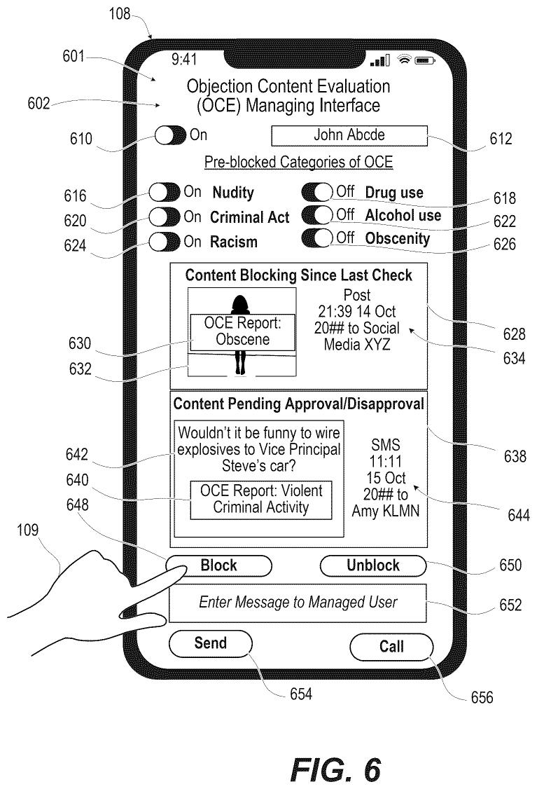

In one or more embodiments, in response to determining that the content includes objectionable content, processor 130 is configured to cause communication device 100 to present a notice via at least one output device 162 indicating that transmission of the content is being blocked and/or that the device is blocking the transmission of at least a portion of the content, based on identifying the objectionable content. In one or more embodiments, processor 130 is configured to cause communication device 100 to activate OCE module 135 to monitor and evaluate whether the content includes objectionable content in response to (i.e., only after previously) receiving an enablement command via communications subsystem 113 from a managing electronic device (e.g., third electronic device 108). For example, in one or more particular embodiments, in response to determining that the content includes objectionable content, processor 130 is configured to cause communication device 100 to transmit a notice via communications subsystem 113 to the managing electronic device (e.g., third electronic device 108) indicating detection of the objectionable content and prevention of transmission of the objectionable content to at least one second electronic device 106. Additional description is provided below with regard to FIG. 6.

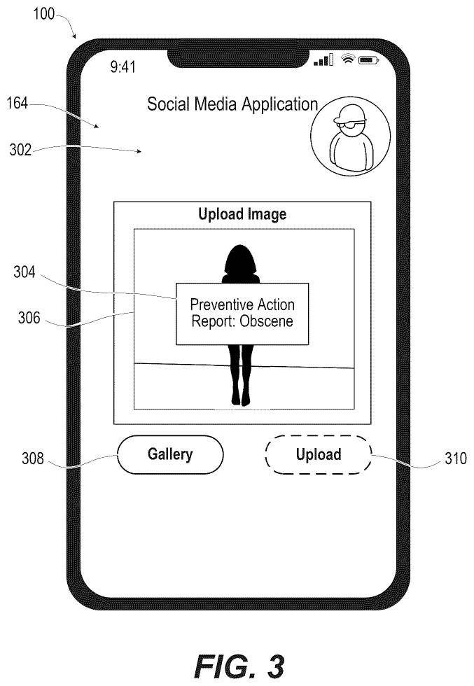

FIG. 3 is a front view of display 164 of communication device 100 presenting an objectionable content evaluation (OCE) interface window 302 for presenting repercussion report 304 and related controls for objectionable image 306. In an example, image 306 may be a video that includes more than one image. AI module 135 (FIG. 1) may analyze each image frame of the video in a manner similar to a single image. In addition, AI module 135 (FIG. 1) may analyze a sequence of image frames of the video to identify objectionable gestures or conduct (e.g., sexual actions, violent gestures, gang symbols, etc.). The analysis by AI module 135 (FIG. 1) may be performed in the background, such as in real-time as the video is captured. The analysis by AI module 135 (FIG. 1) may be performed in a contemporaneous timeframe in response to user selection of a stored video. The video may also include audio. AI module 137 may scan for objectionable graphics, text, spoken speech, bodily motions, and bodily images contained in the video. In an example, the related controls include gallery control 308 for selecting an image and upload control 310 for triggering transmission of a selected image. In one or more embodiments, upload control 310 may be made inactive for a period of time to allow a user to review repercussion report 304. In one or more embodiments, upload control 310 may be made completely inactive unless repercussion report 304 indicates that objectionable image 306 is permissibly objectionable and not impermissibly objection. In one or more embodiments, upload control 310 may be made inactive (de-activated) unless repercussion report 304 has been transmitted to a managing device (e.g., third electronic device 108 of FIG. 1) for presenting to managing user 109 (FIG. 1) and an approving indication is received back from the managing device (e.g., third electronic device 108 of FIG. 1). An example of interactions between managing and managed devices is provided herein with regard to FIGS. 2 and 6.

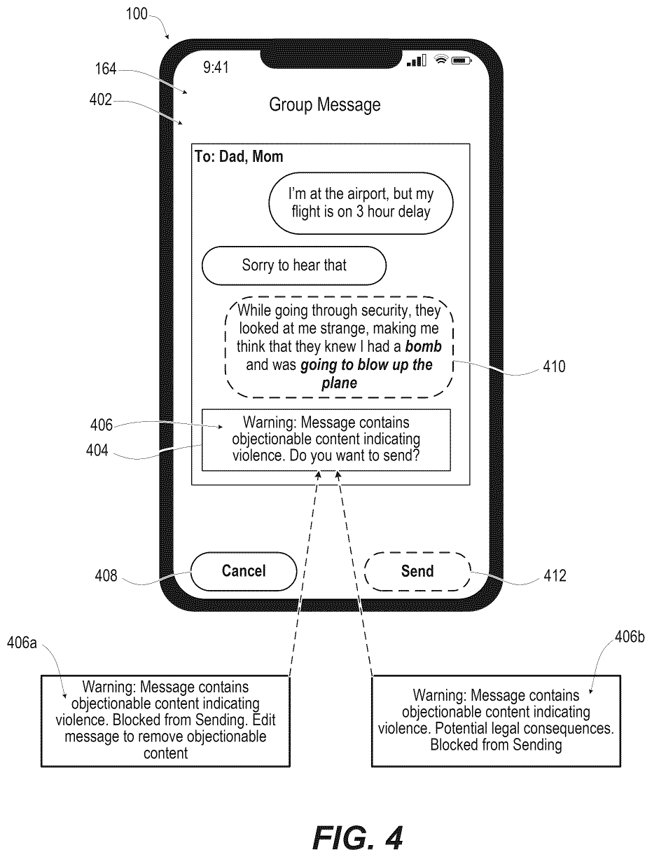

FIG. 4 is a front view of display 164 of communication device 100 presenting texting interface window 402 with popup OCE interface window 404 for presenting repercussion report 406 and related controls for text message content. In an example, the related controls include cancel control 408 to remove objectional text entry 410 and send control 412 for potentially overriding the device's blocking of transmission of objectional text entry 410. In one or more embodiments, annotations are added to point out or highlight elements that are objectionable. In an example, text segments “bomb” and “going to blow up the plane” are annotated in bold italic font to inform a user. Enabling and disabling send control 412 may be identical to features described above for images and videos with regard to FIG. 2. In an example, repercussion report 406 (“Warning: message contains objectionable content indicating violence. Do you want to send?”) may delay transmission but enable transmission after a confirming user input is received. In another example, a different repercussion report 406a (“Warning: message contains objectionable content indicating violence. Blocked from sending. Edit message to remove objectionable content”) may require removal of objectionable content before the remaining/revised content can be transmitted. In a further example, repercussion report 406b (“Warning: message contains objectionable content indicating violence. Potential legal consequences. Blocked from sending.”) provides an explanation, such as a legal basis, for blocking objectionable content.

FIG. 5A is a diagram of a front view of display 164 of communication device 100 presenting texting interface window 402 with popup OCE interface window 404 for presenting a version of repercussion report 406c while communication device 100 is located in restricted location 502. Location repercussion report 514 may inform the user before or after entry of objectional text entry 410 that a higher level of scrutiny is warranted based on location of communication device 100. FIG. 5B is a diagram of a front view of display 164 of communication device 100 presenting texting interface window 402 with popup OCE interface window 404 for presenting a version of repercussion report 406d while communication device 100 is located in unrestricted location 504. In one or more embodiments, activation of objection content evaluation may depend upon the device identifying that it is physically within a restricted location. In one or more embodiments, the actions taken (e.g., classifying content as permissible versus impermissible objectional content) may depend on the device being within a restricted location. In one or more embodiments, the categories of objectionable content that are objectionable or that are impermissibly or permissibly objectionable depend on whether communication device 100 is in restricted location 502 (FIG. 5A) or unrestricted location 504 (FIG. 5B). In an example, with reference to FIG. 5A, in restricted location 502, repercussion report 406c indicates impermissible objectionable content: “Warning: Message contains impermissibly objectionable content indicating violence in this restricted location. Potential legal consequences. Blocked from Sending.” Cancel control 520 and Edit control 522 are active but Send Without Editing control 524 is annotated as being inactive. By contrast, with reference to FIG. 5B, in unrestricted location 504, repercussion report 406d indicates permissible objectionable content: “Warning: Message contains permissibly objectionable content indicating violence in this unrestricted location. Recommend editing”, with selectable options for “edit content” or “send anyway”. Thus, Cancel control 520, Edit control 522 and Send Without Editing control 524 are active.

FIG. 6 is a front view of display 601 of managing electronic device 108 presenting OCE managing interface window 602 for monitoring and controlling OCE functionality of communication device 100 (FIG. 1). Functionality of objectionable content evaluation and blocking may involve interactions between a managed device and a managing device. In an example, a group of users, each with one or more electronic devices, may operate within a group where particular user(s) are given authority to manage particular functions for other user(s) who lack the authority. In one or more embodiments, managing electronic device 108 may have similar or identical components and functionality as communication device 100 (FIG. 1). In one or more embodiments, OCE managing interface window 602 allows selection of one or more managed users/devices depicted as OCE activation/deactivation toggle control 610 and user identification pulldown menu 612.

In one or more embodiments, OCE managing interface window 602 facilitates customized categories of OCE monitoring and responsive action. In an example, OCE managing interface window 602 includes OCE nudity toggle control 616; OCE drug use toggle control 618; OCE criminal act toggle control 620; OCE alcohol use toggle control 622; OCE racism toggle control 624; and OCE obscenity toggle control 626.

In one or more embodiments, OCE managing interface window 602 receives reports in content blocking segment 628 for OCE blocking actions taken at managed devices and any associated unblocking actions allowed. In an example, repercussion report 630 includes obscene image 632 with blocking action status 634 (e.g., “Post, 21:39, 14 October 20 ##, to Social Media XYZ”).

In one or more embodiments, OCE managing interface window 602 facilitates real-time or near real-time intervention and control of objectionable content at managed device (i.e., communication device 100 of FIG. 1) by managing electronic device 108. In an example OCE managing interface window 602 receives reports in content pending segment 638 for OCE blocking actions pending approval or disapproval. Pending repercussion report 640 indicates violent criminal activity referred to in text content 642 (e.g., “Wouldn't it be funny to wire explosives to Vice Principal Steve's car?”). Pending status indicates 644 context information at managed device (i.e., communication device 100 (FIG. 1) for text content 642 (e.g., originating as short message service (SMS) at 11:11 on 15 October 20 ##and intended for Amy KLMN). Block control 648 and unblock control 650 are provided respectively to disapprove/prevent or approve transmission of the objectionable content.

In one or more embodiments, OCE managing interface window 602 facilitates communication between managing user 109 and the managed user (i.e., user 102 of FIG. 1). In an example, text box 652 and send control 654 facilitates managing user 109 entering a text message to send to the managed user. Alternatively, or in addition, call control 656 facilitates initiation of a voice or video call session between managing electronic device 108 and communication device 100 (FIG. 1).

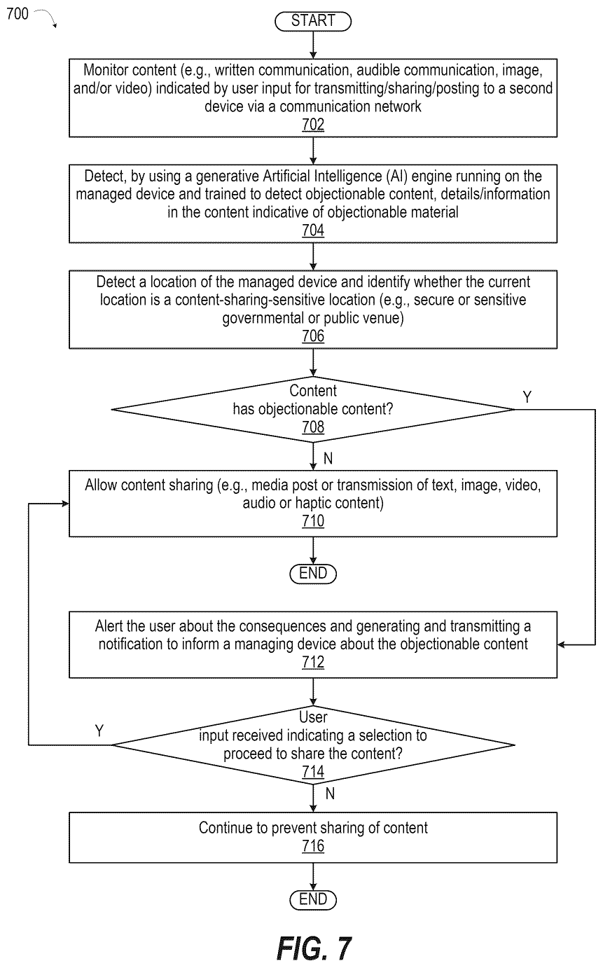

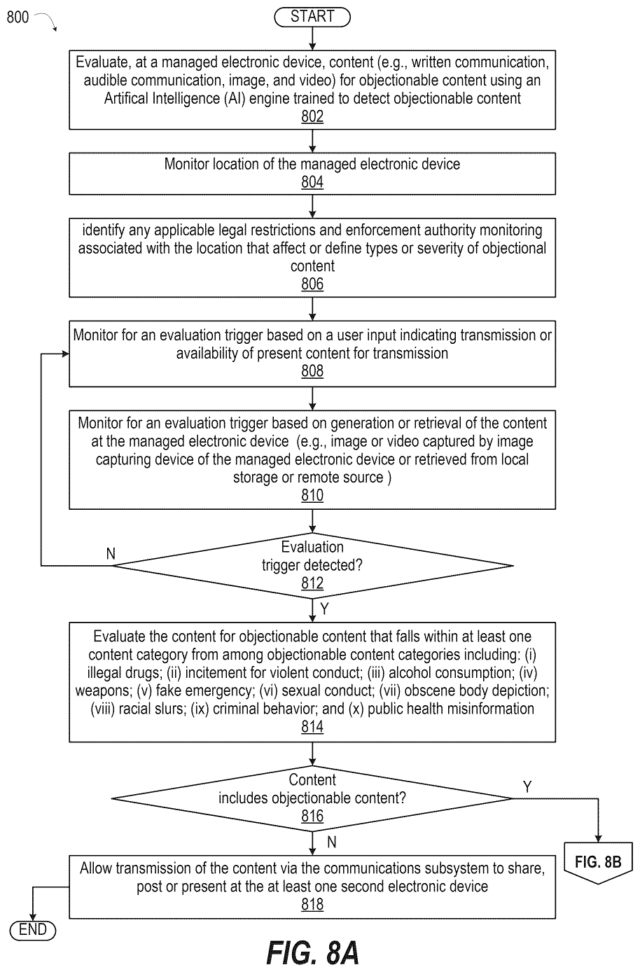

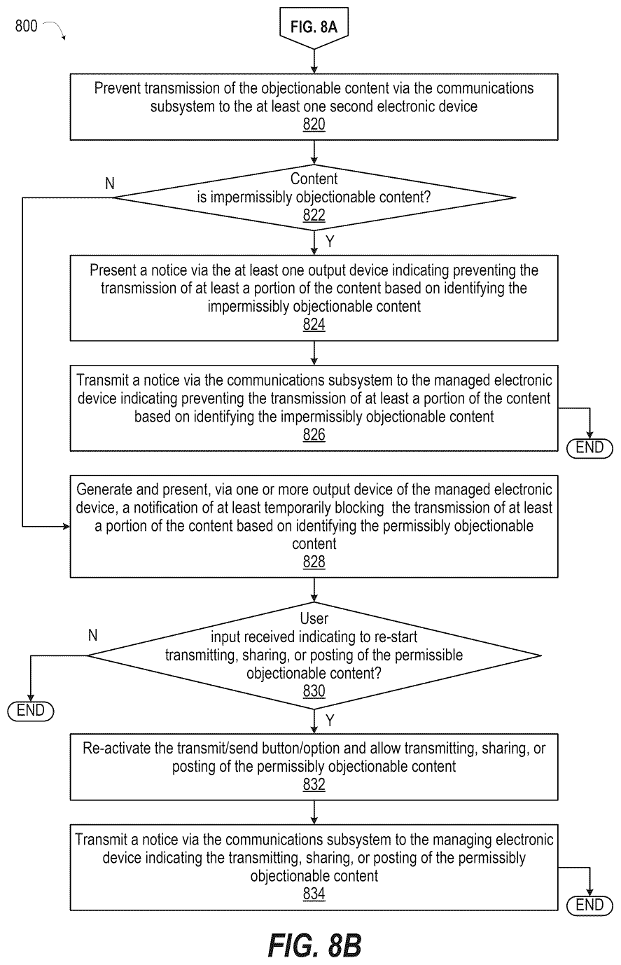

FIG. 7 is a flow diagram presenting method 700 for monitoring a managed device using an AI engine running on the managed device for media or messages that contain objectionable content. FIGS. 8A-8B (collectively “FIG. 8”) are a flow diagram presenting method 800 that prevents transmission of objectionable content to avoid potential negative social or legal repercussions to a user of the electronic device. The description of method 700 (FIG. 7) and method 800 (FIG. 8) are provided with general reference to the specific components illustrated within the preceding FIGS. 1-4, 5A-5B, and 6. Specific components referenced in method 700 (FIG. 7) and method 800 (FIG. 8) may be identical or similar to components of the same name used in describing preceding FIGS. 1-4, 5A-5B, and 6. In one or more embodiments, controller 120 (FIG. 1) configures communication device 100 (FIG. 1) or a similar computing device to provide the described functionality of method 700 (FIG. 7) and method 800 (FIG. 8).

With reference to FIG. 7, method 700 includes monitoring content (e.g., written communication, audible communication, image, and/or video) indicated by user input for transmitting/sharing/posting to a second device via a communication network (block 702). In one or more embodiments, method 700 includes detecting, by using a generative Artificial Intelligence (AI) engine running on the managed device and trained to detect objectionable content, details/information in the content indicative of objectionable material (block 704). Method 700 includes detecting a location of the managed device and identifying whether the current location is a content-sharing-sensitive location (e.g., secure or sensitive governmental or public venue) (block 706). Method 700 includes determining whether the content has objectionable content, e.g., content whose transmission can result in severe/negative repercussions to the user and/or others (decision block 708). In response to determining that the content does not include objectionable content, method 700 includes allowing content sharing (e.g., media post or transmission of text, image, video, audio, or haptic content) (block 710). Then method 700 ends. In response to determining that the content includes objectionable content, method 700 includes alerting the user about the consequences and generating and transmitting a notification to inform a managing device about the objectionable content (block 712). For clarity, method 700 is directed to mitigating the potentially negative repercussions to sharing objectionable content by notifying a user before sharing. Blocking of objectionable content is by delaying sharing until user approval is received, unless an absolute block is imposed, based on the type of objectionable content. Alternative features described below with regard to FIG. 8 include additional options for block objectionable content (e.g., distinguishing permissible and impermissible objectionable content, facilitating editing of objectionable content, and involvement of a managing device).

With continued reference to FIG. 7, method 700 includes determining whether user input is received indicating a selection to proceed to share the content (decision block 714). In response to determining that the user input indicates proceeding to share, method 700 returns to block 710. In response to determining that the user input does not indicate proceeding to share, method 700 includes continuing to prevent sharing of content (block 716). Then method 700 ends.

With reference to FIG. 8A, method 800 includes evaluating, at a managed electronic device, content (e.g., written communication, audible communication, image, and video) for objectionable content using an Artificial Intelligence (AI) engine trained to detect objectionable content (block 802). In one or more embodiments, settings at the managed electronic device may allow a user to enable or disable objectionable content evaluation. In one or more embodiments, settings for enabling or disabling objectionable content evaluation may be remotely set by a managing electronic device as described above with regard to FIGS. 1, 2 and 6. In one or more embodiments, the severity or permissibility of objectional content may depend upon the location of the managed electronic device. In an example, method 800 includes monitoring location of the managed electronic device (block 804). Method 800 includes identifying any applicable legal restrictions and enforcement authority monitoring associated with the location that can affect or define types or severity of objectional content (block 806). Method 800 includes monitoring for an evaluation trigger based on a user input indicating transmission or availability of present content for transmission (block 808). Method 800 includes monitoring for an evaluation trigger based on generation or retrieval of the content at the managed electronic device (e.g., image or video captured by image capturing device of the managed electronic device or retrieved from local storage or remote source) (block 810). In an example, retrieval from remote storage may include downloading an inappropriate image from a server followed by an attempt to share the image. In an example, the transmission includes posting of content to at least one second electronic device associated with a social media system. In another example, the transmission includes sharing of the content to at least one second electronic device, such as a user device, via a communication system. In an additional example, the transmission includes sharing via a social media system or a communication system that is monitored by a third-party enforcement authority for objectionable content. Method 800 includes determining whether an evaluation trigger is detected (decision block 812). In an example, user generation or selection of content constitutes an evaluation trigger. In another example, entering user inputs into a user interface of a communication application constitutes an evaluation trigger. In a further example, selecting a transmit control after entering user inputs into a user interface of a communication application constitutes an evaluation trigger. In yet another example, capturing image, video or audio content by an input device of the managed electronic device constitutes an evaluation trigger. In response to determining that an evaluation trigger is not detected, method 800 returns to block 808.

In one or more embodiments, permissibility of the content may depend on the type or category of objectional content. In response to determining that an evaluation trigger is detected, method 800 may include evaluating the content for objectionable content that falls within at least one content category from among objectionable content categories including: (i) illegal drugs; (ii) incitement for violent conduct; (iii) alcohol consumption; (iv) weapons; (v) fake emergency; (vi) sexual conduct; (vii) obscene body depiction; (viii) racial slurs; (ix) criminal behavior; and (x) public health misinformation (block 814). The list is exemplary and not all inclusive. The categories may be different, such as being based on age, demographic, location, etc., of the user. Method 800 includes determining whether the content includes objectionable content (decision block 816). In response to determining that the content does not include objectionable content, method 800 includes allowing transmission of the content via the communications subsystem to share, post, or present at the at least one second electronic device (block 818). Then method 800 ends.

With reference to FIG. 8B, in response to determining that the content does include objectionable content at the location in decision block 816 (FIG. 8A), method 800 includes preventing transmission of the objectionable content via the communications subsystem to the at least one second electronic device (block 820). In one or more embodiments, the transmission may be prevented in all instances. In one or more embodiments, the transmission may be allowed by a user of the managed electronic device after being warned of the repercussions. In one or more embodiments, the severity of the repercussions, especially at the location, are evaluated before deciding whether the transmission, sharing, or posting may be allowed by the user after notification.

Method 800 may further includes evaluating the objectionable content for a level of severity that corresponds to automatic allowance, to allowance after notification to a user of the managed device, or allowance after notification to a second user of the managing device and approval by that managing user. In an example, method 800 includes determining whether the content is impermissibly objectionable content (decision block 822). In response to determining that the content is impermissibly objectionable content, method 800 includes presenting, via the at least one output device, a notice indicating a blocking of the transmission of at least a portion of the content based on identifying the impermissibly objectionable content (block 824). Method 800 may further include transmitting, via the communications subsystem to the managed electronic device, a notice indicating a blocking of the transmission of at least a portion of the content based on identifying the impermissibly objectionable content (block 826). Then method 800 ends. In response to determining that the content is not impermissibly objectionable content (i.e., permissible objectionable content) in decision block 822, method 800 includes generating and presenting, via one or more output device of the managed electronic device, a notification of at least temporarily blocking the transmission of at least a portion of the content based on identifying the permissibly objectionable content (block 828). Method 800 includes determining whether a user input, received by one or more input device of the managed electronic device, is an override to re-start transmitting, sharing, or posting of the permissible objectionable content (decision block 830). In response to not receiving the user input to proceed, method 800 ends. In response to receiving the user input to proceed, method 800 includes re-activating the transmit/send button/option and allowing transmitting, sharing, or posting of the permissibly objectionable content (block 832). Method 800 includes transmitting a notice via the communications subsystem to the managing electronic device indicating the transmitting, sharing, or posting of the permissibly objectionable content (block 834). Then method 800 ends.

According to aspects of the present disclosure, in response to receiving a user input, via one or more input device of an electronic device, to initiate sharing of content with at least one second electronic device via a communication network, method 800 may include identifying whether the content comprises objectionable content. In response to determining that the content includes objectionable content, method 800 may include preventing transmission of the objectionable content via a communications subsystem of the electronic device to the at least one second electronic device.

In one or more embodiments, method 800 may further include determining a location of the electronic device. Method 800 may further include determining that the content comprises objectionable content at least in part based on the location of the electronic device being monitored by a third party for at least one type of objectionable content. In one or more embodiments, the third party is a law enforcement authority. In one or more particular embodiments, the law enforcement authority enforces a legal restriction that defines the content as objectionable content.

In one or more embodiments, the content may include visual content from at least one of an image and a video. Method 800 may further include evaluating the visual content for objectionable content in response to at least one of detecting: (i) generation or retrieval of the one of the image and the video by an image capturing device of the electronic device; and (ii) the user input selecting the one of the image and the video for transmission.

In one or more embodiments, the content includes one or more of written communication, audible communication, an image, and a video. Method 800 may further include evaluating the content for the objectionable content using an artificial intelligence (AI) module trained to detect objectionable content within the content.

In one or more embodiments, method 800 may further include evaluating the objectionable content as corresponding to either impermissibly objectionable content or permissibly objectionable content. Method 800 may further include generating and presenting a notification of a type of objectionable content found within the content. Method 800 may further include preventing transmission of impermissible objectionable content. Method 800 may further include allowing user selection to enable transmission of objectionable content evaluated as permissibly objectionable.

In one or more embodiments, method 800 may further include determining that the content comprises objectionable content by identifying that the content falls within at least one content category from among objectionable content categories including, but not limited to: (i) illegal drugs; (ii) incitement for violent conduct; (iii) alcohol consumption; (iv) weapons; (v) fake emergency; (vi) sexual conduct; (vii) obscene body depiction; (viii) racial slurs; (ix) criminal behavior; and (x) public health misinformation.

In one or more embodiments, method 800 may further include preventing transmission of the objectionable content based in part on determining that the at least one second electronic device is associated with a social media system. Method 800 may further include presenting a notice via at least one output device of the electronic device indicating a blocking of the transmission of at least a portion of the content based on identifying the objectionable content.

According to aspects of the present disclosure, the communication device 100 (FIG. 1), method 700 (FIG. 7), method 800 (FIG. 8), and computer program product, such as RSD 150 (FIG. 1), prevent transmission of objectionable content to avoid potentially negative social or legal repercussions to a user of the electronic device or to others. In an example, the content may at least be arguably objectionable based on a recipient not understanding an attempt at a humor or satire. In one or more embodiments, activation of objectionable content evaluation is enabled or disabled by a managing device, allowing a managing user to supervise a user of the communication device 100. In one or more embodiments, a level of scrutiny for objectionable content evaluation depends on the device location being in a protected or secure location. In one or more embodiments, the objectionable content evaluation includes levels of prevention that includes permissible and impermissible objectionable content. In one or more embodiments, some impermissible objectionable content may be sent by user input after the user considers and acknowledges/ignores a repercussion report surfaced on the user device.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
at least one user interface component configured to receive user inputs via one or more input device and to present content via one or more output device;
a memory that stores an objectionable content evaluation module and at least one communication application;
a communications subsystem connectable to a communication network; and
a processor communicatively coupled to the memory and the communications subsystem, and which is configured to cause the electronic device to:
in response to receiving a user input to initiate sharing of content with at least one second electronic device via the communication network:
identify whether the content comprises objectionable content; and
in response to determining that the content comprises objectionable content, prevent transmission of the objectionable content via the communications subsystem to the at least one second electronic device.

2. The electronic device of claim 1, further comprising a location module communicatively coupled to the processor, and wherein:
the processor is configured to cause the electronic device to:
determine a location of the electronic device, the location received from the location module; and
perform at least one of: identifies the objectionable content at least in part based on the location of the electronic device; and prevents the transmission of the objectionable content based at least in part on the location of the electronic device being at a location monitored by a third party for at least one type of objectionable content.

3. The electronic device of claim 1, further comprising a location module communicatively coupled to the processor, and wherein:
the processor is configured to cause the electronic device to:
determine a location of the electronic device, the location received from the location module;
determine whether the content comprises objectionable content based on at least one legal restriction that governs the location; and
perform at least one of: identifies the objectionable content at least in part based on the location of the electronic device; and prevents the transmission of the objectionable content based on determining that the content is objectionable content based on at least one restriction that governs the location.

4. The electronic device of claim 1, wherein:
the content comprises visual content from at least one of: (i) text; (ii) an image; (iii) a video; (iv) graphics interchange format (GIF); (v) emoji; (vi) quiz/poll; (vi) online link; (vii) a meme; and
the objectionable content evaluation module comprises an artificial intelligence (AI) module trained to detect objectionable content from within visual content.

5. The electronic device of claim 4, further comprising an image capturing device communicatively coupled to the processor, wherein the processor is further configured to cause the electronic device to evaluate the visual content for objectionable content in response to at least one of detecting: (i) generation of the one of the image and the video by the image capturing device; and (ii) the user input to the one or more input device selecting the one of the image and the video for transmission.

6. The electronic device of claim 1, wherein:
the content comprises audible communication; and
the objectionable content evaluation module comprises an artificial intelligence (AI) module trained to detect objectionable content within audible communication.

7. The electronic device of claim 1, wherein the processor is configured to cause the electronic device to:
evaluate the objectionable content as corresponding to one of at least two categories comprising impermissibly objectionable content and permissibly objectionable content;
generate and present a notification of a type of objectionable content found within the content;
prevent transmission of impermissible objectionable content; and
allow user selection to enable transmission of objectionable content evaluated as permissibly objectionable.

8. The electronic device of claim 1, wherein the processor is configured to cause the electronic device to determine that the content comprises objectionable content by identifying that the content falls within at least one content category from among objectionable content categories comprising: (i) illegal drugs; (ii) incitement for violent conduct; (iii) alcohol consumption; (iv) weapons; (v) fake emergency; (vi) sexual conduct; (vii) obscene body depiction; (viii) racial slurs; (ix) criminal behavior; and (x) public health misinformation.

9. The electronic device of claim 1, wherein, in response to determining that the content comprises objectionable content, the processor is configured to cause the electronic device to present, via the at least one output device, a notice indicating blocking the transmission of at least a portion of the content based on identifying the objectionable content.

10. The electronic device of claim 1, wherein the processor is configured to cause the electronic device to activate the objectionable content evaluation module to monitor and evaluate whether the content comprises objectionable content in response to receiving an enablement command via the communications subsystem from a managing electronic device.

11. The electronic device of claim 10, wherein, in response to determining that the content comprises objectionable content, the processor is configured to cause the electronic device to transmit a notice via the communications subsystem to the managing electronic device indicating detection of the objectionable content and prevention of transmission of the objectionable content to the at least one second electronic device.

12. The electronic device of claim 1, wherein the processor is further configured to cause the electronic device to prevent transmission of the content via the communications subsystem to the at least one second electronic device at least in part in response to determining that the at least one second electronic device is associated with a social media system.

13. A method comprising:
in response to receiving a user input, via one or more input device of an electronic device, to initiate sharing of content with at least one second electronic device via a communication network:
identifying whether the content comprises objectionable content; and
in response to determining that the content comprises objectionable content, preventing transmission of the objectionable content via a communications subsystem of the electronic device to the at least one second electronic device.

14. The method of claim 13, further comprising:
determining a location of the electronic device; and
determining that the content comprises objectionable content at least in part based on the location of the electronic device being one of monitored by a third party for at least one type of objectionable content.

15. The method of claim 13, wherein the content comprises visual content from at least one of an image and a video, and the method further comprises evaluating the visual content for objectionable content in response to at least one of detecting: (i) generation of the one of the image and the video by an image capturing device of the electronic device; and (ii) the user input to the one or more input device selecting the one of the image and the video for transmission.

16. The method of claim 13, wherein:
the content comprises one or more of written communication, audible communication, an image, and a video; and
evaluating the content for the objectionable content comprises using an artificial intelligence (AI) module trained to detect objectionable content within the content.

17. The method of claim 13, further comprising:
evaluating the objectionable content as corresponding to one of at least two categories comprising impermissibly objectionable content and permissibly objectionable content;
generating and presenting a notification of a type of objectionable content found within the content;
preventing transmission of impermissible objectionable content; and
allowing user selection to enable transmission of objectionable content evaluated as permissibly objectionable.

18. The method of claim 13, further comprising determining that the content comprises objectionable content by identifying that the content falls within at least one content category from among objectionable content categories comprising: (i) illegal drugs; (ii) incitement for violent conduct; (iii) alcohol consumption; (iv) weapons; (v) fake emergency; (vi) sexual conduct; (vii) obscene body depiction; (viii) racial slurs; (ix) criminal behavior; and (x) public health misinformation.

19. The method of claim 13, further comprising:
preventing transmission of the objectionable based in part on determining that the at least one second electronic device is associated with a social media system; and
presenting a notice via at least one output device of the electronic device indicating blocking the transmission of at least a portion of the content based on identifying the objectionable content.

20. A computer program product comprising:
a computer readable storage device; and
program code on the computer readable storage device that when executed by a processor associated with an electronic device, the program code is configured to cause the electronic device to provide functionality of:
in response to receiving a user input, via one or more input device of the electronic device, to initiate sharing of content with at least one second electronic device via a communication network:
identifying whether the content comprises objectionable content; and
in response to determining that the content comprises objectionable content, preventing transmission of the objectionable content via a communications subsystem of the electronic device to the at least one second electronic device.
